(19) United States
(12) Patent Application Publication
(10) Pub. No.: US 2006/0032723 A1
(43) Pub. Date: Feb. 16, 2006

(54) BTSI with lead frame switch

(76) Inventor: Darrin F. Wilber, Metamora, MI (US)

Correspondence Address: Thomas N. Young;Young & Basile, P.C., Suite 624, 3001 W. Big Beaver Road, Troy, MI, 48084, US

(21) Appl. No.: 10/916,887

(22) Filed: Aug. 12, 2004

(51) Int. Cl. B60W 10/18

(52) U.S. Cl. 192/220.4

(57) ABSTRACT

A releasable shifter lock for use in automotive brake-shift interlock systems comprising a two-part molded plastic housing containing integral guides for a beam-type plastic blocker bar. A pull-type solenoid attached to the BTSI housing has an external armature extending into a metal insert in the blocker member. When the solenoid is energized, the armature pin is withdrawn to free up the blocker member for sliding movement so that the shifter mechanism can be operated in the normal fashion. A serrated, two-sided Neoprene band mounted on the external armature assembly provides positive mechanical stops in both extending and retracting directions with a minimum of noise. A lead frame comprising flat stock conductors operates in conjunction with a sliding contact on the blocker member to perform a switching function to energize and deenergize the solenoid as well as any associated ignition key lock.

### FIELD OF THE INVENTION

This invention relates to automotive brake-shift interlock systems commonly called BTSI's and more particularly to a releasable shifter lock for use in such systems.

### BACKGROUND OF THE INVENTION

Brake-shift interlocks and brake-shift-ignition interlocks came into common use in automobiles sold for use within the United States as a solution for problems associated with unintended vehicle acceleration. The objective of such systems is to prevent automatic transmissions from being shifted out of the “PARK” condition when the engine is running until such time as the driver of the automobile places a foot on the brake pedal and depresses the brake pedal sufficiently to close the brake light switch. This objective can be accomplished through the use of an electromagnetic device such as a solenoid which locks the shifter detent until depression of the brake pedal changes the state of the device. One prior art system is disclosed in U.S. Pat. No. 5,938,562 to Charles D. Withey.

The Withey patent describes a shifter lock having a “lead frame” disposed within a plastic housing for connecting the solenoid coil to external circuitry and ultimately to the vehicle battery. The term “lead frame” is used herein to refer to a set of metal conductors, typically stamped from flat metal stock, which are arranged in a coplanar fashion on an inside wall of a plastic housing to define certain circuits and connections. The Withey lead frame is formed in such a way as to define a set of non-coplanar spring contacts which open and close according to the movement of toggle components within the housing to switch the application of battery voltage from the solenoid to an ignition key lock when the shifter lever of the vehicle is operated.

A disadvantage of the Withey system arises out of the design of the switch. The Withey switch provides a relatively small contact surface and no significant wiping action when the switch is exercised. This can cause switch malfunction due to oxidation of metal surfaces. Another disadvantage of the Withey shifter lock arises out of the use of a toggle linkage which is complex and expensive to manufacture and assemble.

### SUMMARY OF THE INVENTION

The present invention provides a shifter lock which overcomes the disadvantages of the Withey device described above in that it eliminates the spring contact switch in favor of a sliding contact switch and further eliminates the toggle mechanism with its multiple components in favor of a simple sliding member.

In general, the present invention is a releasable shifter lock for use in an automotive brake-shift interlock system including a plastic housing preferably made in two mating parts each of which has an interior surface. The housing provides a mount for a solenoid having a coil and an armature. The inside surfaces of the housing parts define a slideway for a blocker member mounted within the housing for reciprocal sliding movement between a first position which locks an associated shifter and a second position which releases an associated shifter for normal operation. The solenoid armature assembly fits into the blocker member to lock the blocker member in one state and to unlock the blocker member in another state. In the preferred form, said “one” state is the energized state and the “another” state is the deenergized state. Also, the solenoid armature assembly includes a pin which extends into an aperture in the blocker member and which is pulled from the aperture in the blocker member when energized so as to release the blocker member for sliding movement.

In accordance with the invention, a lead frame comprising multiple flat stock conductors is mounted on an interior surface of the housing and, in conjunction with sliding contacts on the blocker member, defines a switch which controls the energization and deenergization of the solenoid and, where desired, the energization and deenergization of an associated ignition key lock. The sliding motion of the lead frame switch contacts is such as to remove any oxidation which might accumulate on the metal surfaces of the lead frame and eliminate poor conductivity contacts previously associated with open contact non-sliding switches such as that switch which is described in the aforesaid Withey patent.

In the preferred form, the housing is made with opposing internal projections which define a slideway for a blocker member. The blocker member is designed as a rectangular plastic beam with webs of constant thickness to prevent warpage. A central aperture in the beam receives a metal insert which, in turn, receives the armature structure to prevent movement of the blocker relative to the housing. The lead frame is heat staked to the interior of the housing and the switch is formed by placing a sliding conductor on the blocker where it slidingly engages the flat lead frame conductors.

Another advantage of the invention is reduced operating noise. In general, this is achieved by providing a soft plastic bumper on the solenoid armature which provides low-noise mechanical stops in both extruded and retracted positions.

Other applications of the present invention will become apparent to those skilled in the art when the following description of the best mode contemplated for practicing the invention is read in conjunction with the accompanying drawing.

### BRIEF DESCRIPTION OF THE DRAWING

The description herein makes reference to the accompanying drawing wherein like reference numerals refer to like parts throughout the several views, and wherein:

FIG. 1 is a perspective view of a brake-shift interlock system including a representative conventional floor-mounted shifter mechanism;

FIG. 2 is a perspective view of a releasable shifter lock constructed in accordance with the present invention with one of the housing components removed to reveal the interior components thereof;

FIG. 3 is a plan view of the device of FIG. 2;

FIG. 4 is a plan view of the device of FIG. 3 with the solenoid energized to retract the armature assembly;

FIG. 5 is a top view of the sliding blocker member in the shifter lock of FIGS. 2-4;

FIG. 5A is an end view along the section line in FIG. 5; and

FIG. 6 is an end view in section of the shifter lock of FIGS. 2-5 showing a mechanical stop which is provided for the armature assembly in the extended condition.

### DETAILED DESCRIPTION OF THE PREFERRED EMBODIMENT

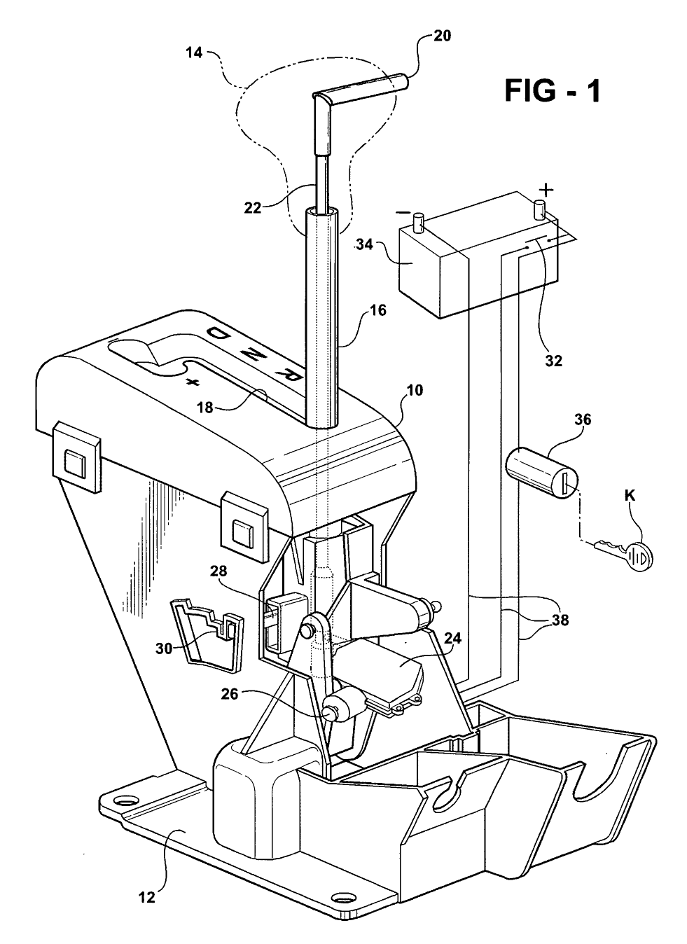

Referring first to FIG. 1, a conventional shifter mechanism 10 for automobiles equipped with automatic transmissions is shown to have a base 12 adapted to be secured to the interior floor of the vehicle where it can be conveniently reached by the operator of the vehicle. The shifter mechanism 10 comprises a shifter handle 14 connected to a pivotal shift lever 16 which can be manually manipulated to move within a slot 18 between positions corresponding to “PARK,” “REVERSE,” “NEUTRAL,” and “DRIVE.” The shifter handle 14 is equipped with a side mounted push button 20 which, through a known mechanism, causes vertical movement of a shifter rod 22 extending down the center of lever 16 to move a bar 28 out of the “PARK” position in a detent 30 to permit free motion of the shift lever 16 in conventional fashion. The shifter lock 24 hereinafter described in detail prevents movement of the bar 28 out of the detent 30 until such time as the brake pedal (not shown) is depressed sufficiently to close a switch 32 associated with a circuit to the vehicle battery 34. The circuit may include a connection to a conventional ignition switch key lock 36 as hereinafter described.

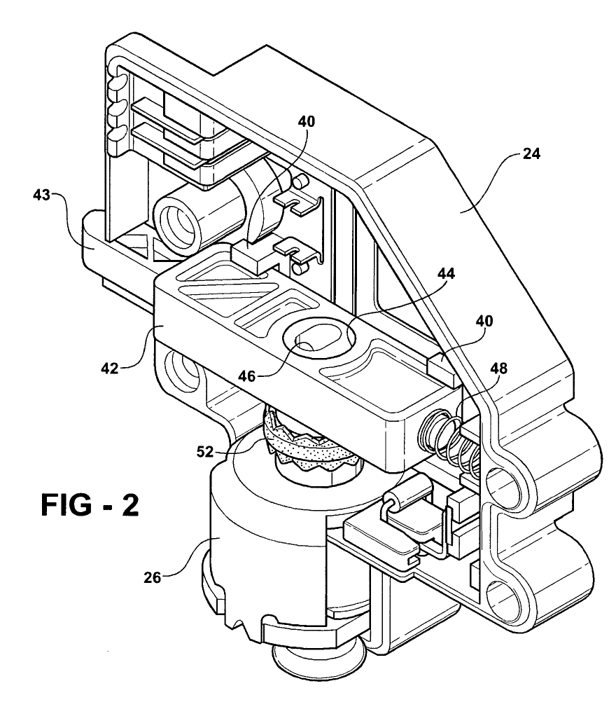

The circuit comprising the switch 32, the battery 34 and the ignition key switch lock 36 is connected by wires 38 to releasable shifter lock 24 having a two-part plastic housing hereinafter described with reference to FIGS. 2-4. The plastic housing carries an electromagnetic device in the form of a solenoid 26 the energization of which is controlled by the BTSI circuit in a manner hereinafter described.

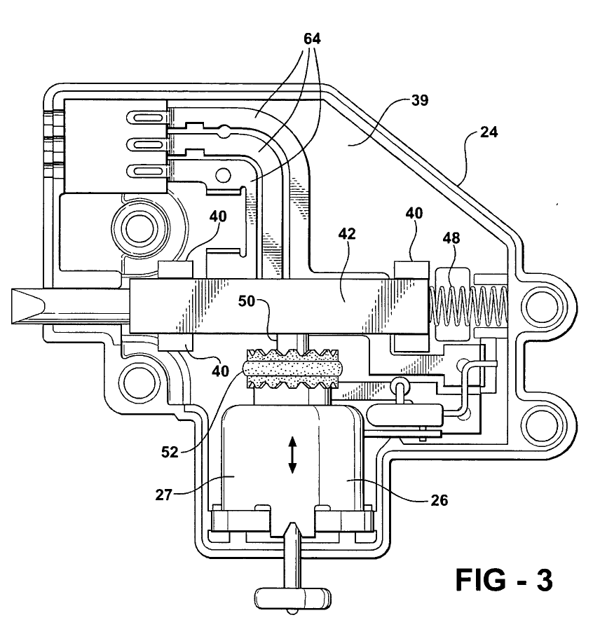

Referring to FIGS. 2-6, the BTSI housing 24 is preferably made in the form of two mating plastic shells which can be welded, bonded, or screwed or otherwise fastened together to form a protective enclosure having at least two primary opposite interior surfaces 39. The housing is adopted to be mounted on the shifter mechanism 10 as shown in FIG. 1. Molded integrally with interior surface 39 are guide members 40 which provide a slideway for a molded plastic blocking member 42 having a webbed beam-like structure including a substantially central aperture 44 containing a metal insert 46. The blocking member 42 is molded integral with a pin 43 which extends from the BTSI housing 24 as shown in FIGS. 2 and 3 into interfering relationship with the shifter rod 22 described with reference to the structure of FIG. 1. In general, when the pin is extended, the shifter can not be operated, whereas when the pin is withdrawn by pushing the blocking member 42 from left to right against the bias of a coil spring 48, the shifter is unlocked and released for normal operation. The blocker member 42 is H-shaped in cross section as best shown in FIG. 6 and fits between the projections 40. The member 42 is designed as a webbed beam with all planar portions of substantially the same thickness to prevent warpage. Secondary projections 45 provide lateral support for blocker member 42 also as shown in FIG. 6.

The solenoid 26 comprises a conventional metal can 27 and a bobbin-wound coil (not shown) which controls the position of an armature structure 50 which, when the solenoid is deenergized, is caused by an internal spring to extend upwardly into the central aperture of the insert 46 in the blocker member 42 to prevent the blocker member 42 from moving either left or right within the longitudinal slideway provided by guides 40 and 45. When the solenoid coil is energized, the armature pin 50 is withdrawn and the blocker member is free to slide in both directions, the force tending to urge the blocker member 42 and pin 43 into the BTSI housing 24, coming from the manual operation of the shifter handle 14. A bias spring 48 provides the return force. The aperture in the blocker is oblong to make it easier for the armature to be inserted therein during operation of the system.

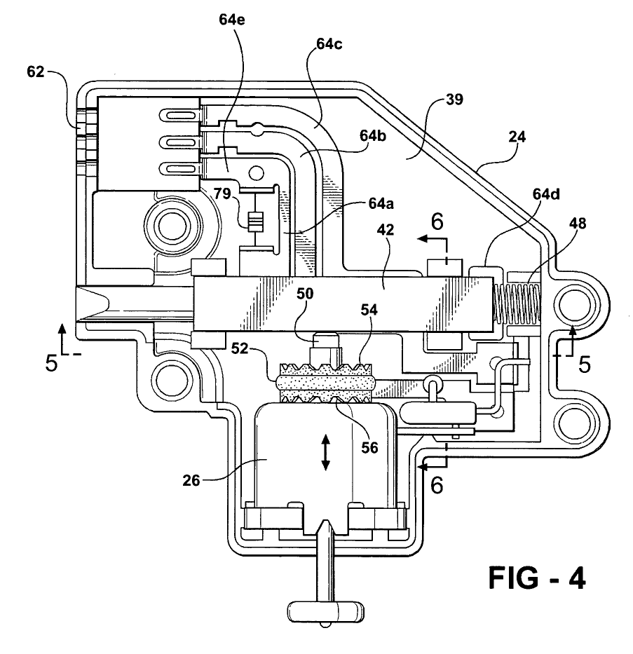

A molded Neoprene bumper 52 is disposed around the large diameter portion of the external armature structure and has serrated or crenelated opposite annular surfaces 54 and 56. The surface 54 provides a mechanical stop against interior surface 58 of the BTSI housing 24 as shown in FIG. 6. The lower serrated surface 56 provides a mechanical stop against the top of the solenoid can as best shown in FIG. 4. The mechanical stops are preferably set to engage before the pole piece of the solenoid hits any internal stops. The resilient material of the bumper 52 thus reduces mechanical shock and noise during operation of the solenoid 26.

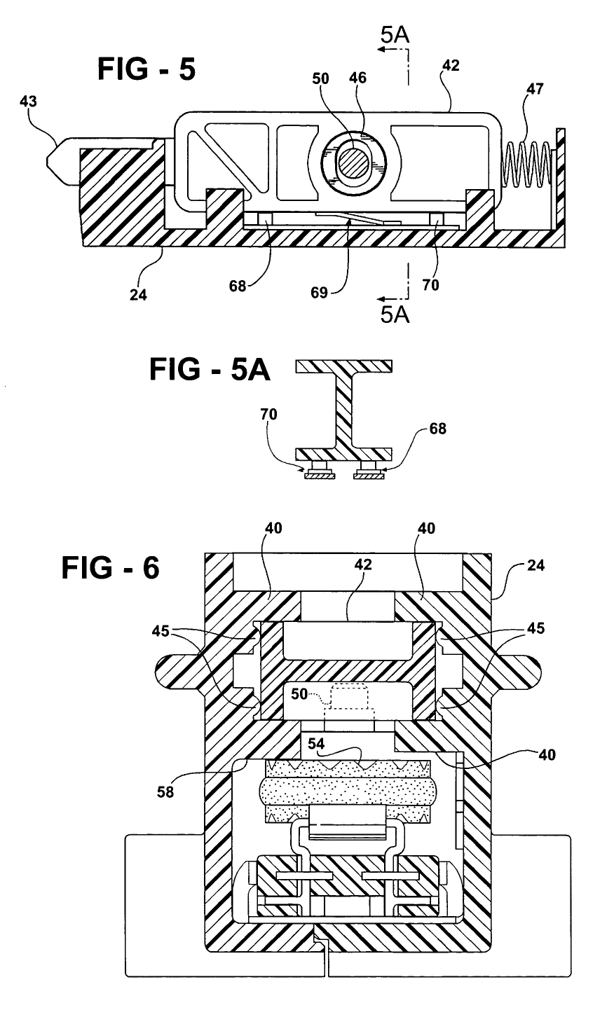

A lead frame 64 of flat conductive stock is fashioned from a stamping and cutting operation and secured to the inside surface 39 of the BTSI housing 24 by heat staking or other suitable procedures. The conductors 64a, 64b, 64c, 64d, and 64e of the lead frame 64 are connected through port 62 in the housing 24 to the wires 38 which form the overall BTSI wiring system as shown and described with reference to FIG. 1. Contacts 69 are disposed on an edge surface of the blocker member 42 as shown in FIG. 5 to make and break solenoid and ignition key lock energization/deenergization circuits according to the position of the sliding blocker member 42 during operation of the device as hereinafter described.

The lead frame 64 may also have portions which are bent up out of the plane of the surface 39 to receive capacitors and/or diodes for noise suppression and diodes for other circuit purposes well known to those skilled in the art. Some of the flat conductors 64a, 64b, 64c, 64d, and 64e of the lead frame 64 are arranged as shown in FIG. 4 to extend under the blocker member 42. The metal contact member 69 having sliding contact projections 68, 70 engages and slides on the lead frame conductors 64 to perform a switching function as more fully described in the co-pending application attorney docket INC-118-A filed concurrently herewith in the name of Weston C. Bye, the entire disclosure of which is incorporated herein by reference. As described in the Bye application, flat conductor 64b is a ground line which one slider contact slidingly engages regardless of position. The conductors 64d and 64e form the solenoid energizing path and, together with conductor 64b, define a gap across which the contact member 69 extends. Conductor 64c extends to a position adjacent but spaced from an end of conductor 64b which is connected to the ignition key lock 36. The other sliding contact 68, 70 slides across the gap from conductor 64d to conductor 64c to deenergize the solenoid and energize the ignition key lock as the slider 40 moves into the housing 24 as shown in FIG. 4.

### Operation

In operation, the shifter 10 is normally in the “PARK” position and the solenoid is deenergized. When the ignition key is inserted and the engine of the automobile carrying the system is started, the solenoid 26 is initially deenergized and an internal spring (not shown) urges the pin 50 into the aperture of the insert 46 in the blocker member 42. As such, the blocker member is immobilized and it is not possible to depress the push button 20 in the shifter 10 to remove the shifter mechanism from the “PARK” condition. When the operator of the vehicle presses on the brake pedal to close the switch 32, the solenoid 26, which is of the “pull” type, is energized through the lead frame 64 to withdraw the pin 50 toward or into the solenoid can as shown in FIG. 4. This causes the serrated surface 56 of the band 52 to engage the top surface of the solenoid can to provide a quiet mechanical stop. With the pin 50 pulled from the aperture in the insert 46, the blocker member 42 is free to move within the slideway 40 and, accordingly, the shifter mechanism can be operated in the normal fashion. When the blocker member 42 is moved from left to right as shown in FIGS. 2-4, the sliding contacts 64 move over a gap in the lead frame from conductor 64d to conductor 64c to deenergize the solenoid 26 and energize the ignition key lock 36. The automobile can be operated in the normal fashion with movements of the shift lever and other vehicle functions in full effect until such time as the shifter is returned to the “PARK” position. At that time, the deenergized solenoid is mechanically urged by the internal bias spring into the position wherein the pin 50 fits back into the aperture in the insert 46 and the shifter mechanism 10 is again immobilized.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A releasable shifter lock for use in an automotive brake-shift interlock system comprising:
a housing having an interior surface;
a blocker member mounted within the housing for movement between a first position which locks an associated shifter and a second position which releases an associated shifter;
a solenoid mounted to the housing and having an armature assembly for locking the blocker member when energized and unlocking the blocker member when deenergized;
a lead frame mounted on said interior surface; and
a switch including contacts mounted on the blocker member and slidably engaging the lead frame for controlling the energization and deenergization of the solenoid.

2. The releasable shifter lock defined in claim 1 wherein the blocker member is formed as a webbed plastic bar with a central aperture, said solenoid armature assembly fitting into the aperture when the solenoid is deenergized.

3. The releasable shifter lock defined in claim 2 further including a metal insert disposed within the central aperture of the plastic bar to receive said armature assembly therein, wherein the webs of the bar are of substantially constant thickness.

4. The releasable shifter lock defined in claim 3 further including a coil spring for biasing the plastic bar toward the locking position.

5. The releasable shifter lock defined in claim 2 further including guide means integrally formed with the housing to support the blocker member for longitudinal sliding movement.

6. The releasable shifter lock defined in claim 1 wherein said armature assembly includes a resilient band disposed around the armature assembly to provide a stop against the solenoid when energized and to provide a stop against the housing when the solenoid is deenergized.

7. The releasable shifter lock defined in claim 6 wherein the resilient band has opposite serrated edges to provide said stops.

8. The releasable shifter lock defined in claim 1 wherein the lead frame comprises at least three flat stock conductors.

9. A releasable shifter lock for use in automotive brake-shift interlock systems comprising:
a housing having an interior surface;
a blocker member mounted within the housing for movement between a first position which locks an associated shifter and a second position which releases an associated shifter;
a solenoid comprising an actuator rod which retracts from the solenoid into the housing when the solenoid is energized;
a lead frame comprising flat stock conductors mounted on said interior surface; and
a switch including a sliding contact member mounted on said blocker member and engaging the lead frame conductors for controlling the energization and deenergization of the solenoid according to the position of the blocker member.

10. In a shifter lock for use in an automotive brake-shift interlock system:
a housing having an integral internal slideway;
a blocker bar movable within the slideway from a rest position and having an electrical contact disposed thereon;
a solenoid having an armature biased into interfering relationship with the blocker bar; and
a lead frame mounted to and internally of the housing to control energization of the solenoid, the lead frame, together with the electrical contact on the bar, defining a switch which deenergizes the solenoid when the bar is moved from the rest position.
